(19) United States
(12) Patent Application Publication
(10) Pub. No.: US 2019/0205551 A1
(43) Pub. Date: Jul. 4, 2019

(54) DISTRIBUTED COMPUTING SYSTEM

(71) Applicant: OKEANOS CORPORATION, Grand Cayman (KY)

(72) Inventors: John Yao-Ting LEE, Taipei City (TW); Jia-Cheng LIN, Shenzhen City (CN)

(21) Appl. No.: 16/234,369

(22) Filed: Dec. 27, 2018

(30) Foreign Application Priority Data
Dec. 28, 2017 (TW) 106146113

(51) Int. Cl. G06F 21/60; H04L 29/08

(52) U.S. Cl. CPC G06F 21/606; H04L 67/10; G06F 21/602

(57) ABSTRACT

Disclosed is a distributed computing system, comprising: a computing task managing device being configured to receive information to be processed then distributed into a plurality of information pieces provided for performing an individual task, the computing task managing device being provided with an information ciphering module configured to encrypt the information pieces; and a computing cluster device receiving the encrypted information piece to be processed, which includes at least one bridging computing module including a plurality of bridging computing units connected in series, and at least one subordinating computing module including a plurality of subordinating computing units connected in series, wherein an end of the serial connected bridging computing units is taken as an end bridging computing unit to connect the computing task managing device, and an end of the serial connected subordinating computing units is taken as an end subordinating computing unit to connect the end bridging computing unit.

### FIELD OF THE INVENTION

The present invention relates to a distributed computing system, and more particularly relates to a distributed computing system which is configured to distribute and encrypt information to be processed and is configured to dispatch a plurality of computing units so as to compute the information to be processed.

### BACKGROUND OF THE INVENTION

The prior implementation of dealing with complex computing tasks is known as connecting an information device, such as a personal computer, to a supercomputing center, which is provided with multiple high-performance terminal computing equipment so as to perform a computing process. In the computing process, the information device is connected to a dispatcher such that the information to be processed within the information device is transmitted to the terminal computing equipment. Furthermore, according to an evaluation with respect to the amount of work that the information is to be processed, the dispatcher dispatches several terminal computing equipments in the supercomputing center to perform a parallel computing process on the information to be processed.

However, the dispatcher can only accord the total amount of work in the current computing task to dispatch terminal computing equipment for the operation of the parallel computing process, but can neither perform the dispatch the computing task according to the information to be processed, nor know the detailed working status of all terminal computing equipments in the supercomputing center. As a result, the dispatcher cannot perform an appropriate and flexible working dispatch and assignment for all terminal computing equipments, and the overall working efficiency of the supercomputing center is low.

Moreover, information transmitted between the dispatcher and the terminal computing equipments is not encrypted, and the terminal computing equipments also handle a general-purpose computing which performs the computing processes for different information devices. Therefore, in the case that one terminal computing equipment is used for information transmissions of different information devices, data of one information device processed by the terminal computing equipment may be leaked to another information device such that there is a risk of data leakage of important information from specific information devices.

### SUMMARY OF THE INVENTION

Accordingly, in order to solve above problems, one objective of the present invention is to provide a distributed computing system that is able to distribute and encrypt information to be processed and is able to dispatch a computing unit so as to compute the information to be processed.

In order to overcome the technical problems in prior art, the present invention provides a distributed computing system, comprising: a computing task managing device being configured to receive, from an information device which is connected to the computing task managing device, information to be processed and distribute the information to be processed into a plurality of information pieces to be processed, each information piece to be processed being provided for performing an individual task, the computing task managing device being provided with an information ciphering module which is configured to encrypt the information pieces to be processed to obtain a plurality of encrypted information pieces to be processed; and a computing cluster device receiving the encrypted information piece to be processed, the computing cluster device including at least one bridging computing module and at least one subordinating computing module, the bridging computing module including a plurality of bridging computing units which are connected in series, and the subordinating computing module including a plurality of subordinating computing units which are connected in series, wherein an end of the serial connected bridging computing units is taken as an end bridging computing unit to connect the computing task managing device, and an end of the serial connected subordinating computing units is taken as an end subordinating computing unit to connect the end bridging computing unit, wherein the computing task managing device is configured to monitor a working status of each bridging computing unit to obtain a bridging computing unit feedback and monitor a working status of each subordinating computing unit to obtain a subordinating computing unit feedback such that according to the each bridging computing unit feedback and the each subordinating computing unit feedback, the plurality of encrypted information pieces to be processed is assigned to the bridging computing unit whose bridging computing unit feedback indicating as in an idle state and/or the subordinating computing unit whose subordinating computing unit feedback indicating as in an idle state to obtain a plurality of computing results from the assigned bridging computing unit and the assigned subordinating computing unit, and wherein the end bridging computing unit is configured to return the plurality of computing results to the computing task managing device, the information ciphering module is configured to decrypt the plurality of computing results, and the computing task managing device is configured to obtain decrypted computing information from the plurality of decrypted computing results and return the decrypted computing information to the information device.

In one embodiment of the present invention, the distributed computing system is provided, wherein the plurality of bridging computing units are arranged in a straight line and adjacent two of the bridging computing units are informationally connected with each other, the end bridging computing unit is arranged at an end of the straight line, and the bridging computing unit arranged at the other end of the straight line is informationally connected to the end bridging computing unit to return the computing results of the plurality of bridging computing units to the computing task managing device.

In one embodiment of the present invention, the distributed computing system is provided, wherein the plurality of subordinating computing units are arranged in a straight line and adjacent two of the subordinating computing units are informationally connected with each other, the end subordinating computing unit is arranged at an end of the straight line, and the subordinating computing unit arranged at the other end of the straight line is informationally connected to the end bridging computing unit to return the computing results of the subordinating computing units to the computing task managing device via the end bridging computing unit.

In one embodiment of the present invention, the distributed computing system is provided, wherein the computing task managing device is further provided with an information transmission module connected to the information device and the information ciphering module to transmit the information to be processed to be encrypted to the information ciphering module and return the decrypted computing information to the information device.

In one embodiment of the present invention, the distributed computing system is provided, wherein the plurality of bridging computing units and the plurality of subordinating computing units are arranged in a checkerboard matrix.

In one embodiment of the present invention, the distributed computing system is provided, wherein the bridging computing unit and the subordinating computing unit are a unified processing unit or computing network configured to exclusively perform a computing operation.

The distributed computing system according to the embodiment of the present invention has technical effects as follows: the computing task managing device accords the computing unit feedback from the plurality of computing units of the computing cluster device to distribute the information to be processed of the information device and to dispatch the idle computing units as computing units to perform the computing operation for the information to be processed so as to balance the computing load of the computing cluster device and thus improve the work efficiency. The plurality of computing units is unified to have similar computing processing capacities and can handle a condition of complex computational requirement by normalized operations through a networked combined operation. Furthermore, the information ciphering module of the computing task managing device is configured to encrypt the information to be processed and decrypt the computing result such that the information transmission between the computing task managing device and the computing cluster device can be in a secure information connection. Moreover, by the one-way information transmission operating between the bridging computing unit and the subordinating computing unit, the information transmission in the computing cluster device is fast and efficient and thereby contributing to the efficiency improvement of the distributed computing system.

### BRIEF DESCRIPTION OF THE DRAWINGS

FIG. 1 is a schematic block diagram illustrating the architecture of a distributed computing system according to an embodiment of the present invention; and

FIG. 2 is a schematic timing diagram illustrating an operation of the distributed computing system according to an embodiment of the present invention.

### DETAILED DESCRIPTION OF THE PREFERRED EMBODIMENTS

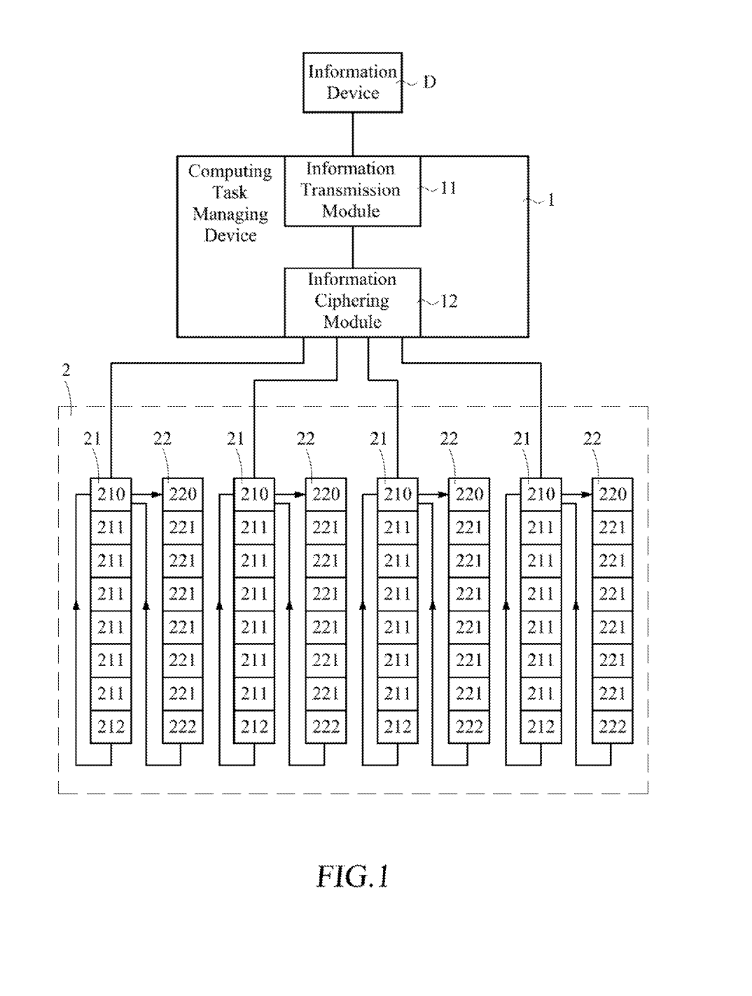

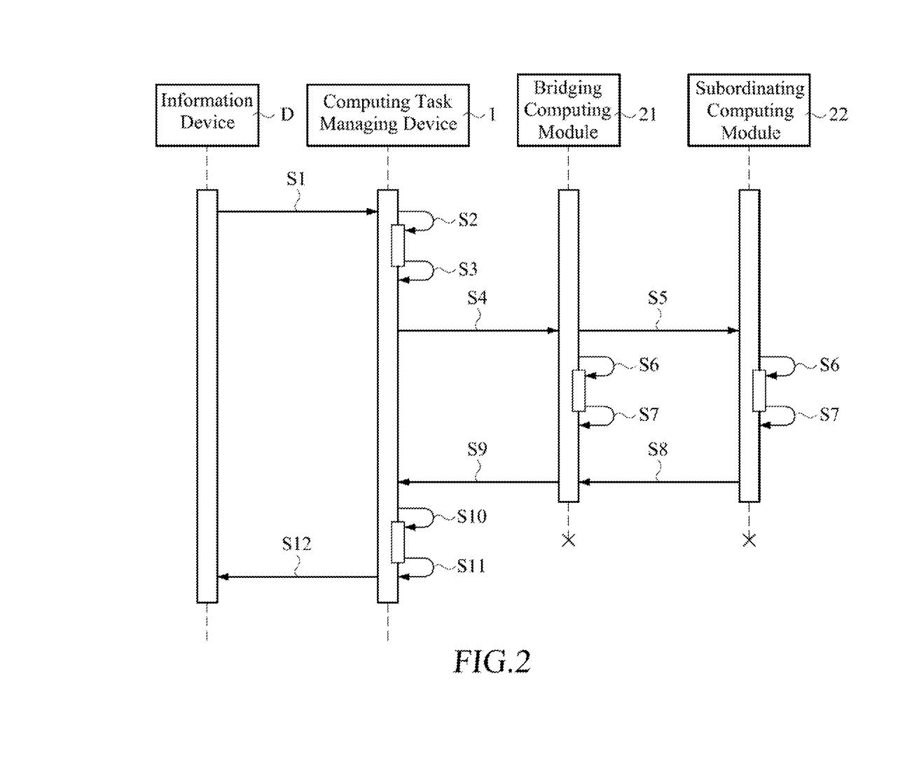

The preferred embodiments of the present invention are described in detail below with reference to FIG. 1 and FIG. 2. The description is used for explaining the embodiments of the present invention only, but not for limiting the scope of the claims.

Please refer to FIG. 1 and FIG. 2, a distributed computing system according to an embodiment of the present invention comprises a computing task managing device 1 being configured to receive, from an information device D which is connected to the computing task managing device 1, information to be processed and distribute the information to be processed into a plurality of information pieces to be processed, each information piece to be processed being provided for performing an individual task, the computing task managing device 1 being provided with an information ciphering module 12 which is configured to encrypt the information pieces to be processed to obtain a plurality of encrypted information pieces to be processed; and a computing cluster device 2 including at least one bridging computing module 21 and at least one subordinating computing module 22.

The operation timing of the distributed computing system according to an embodiment of the present invention is shown in FIG. 2, wherein in a step S1, the information device D transmits information to be processed to the computing task managing device 1, in a step S2, the computing task managing device 1 distributes and encrypts the information to be processed, and thereby, in a step S3, a plurality of encrypted information pieces to be processed are obtained. In a step S4, the computing task managing device 1 transmits the plurality of encrypted information pieces to be processed to the bridging computing module 21 and, in a step S5, transmits a part of the encrypted information pieces to the subordinating computing module 22 via the bridging computing module 21. In a step S6, the bridging computing module 21 and the subordinating computing module 22 perform computing operations respectively and, in step S7, obtain a plurality of computing results. In a step S8, the subordinating computing module 22 returns a part of the computing results to the bridging computing module 21 and, in a step S9, the bridging computing module 21 returns the computing results to the computing task managing device 1. In a step S10, the computing task managing device 1 decrypts the plurality of computing results to, in a step S11, obtain decrypted computing information and, in a step S12, returns the decrypted computing information to the information device D.

In detail, as shown in FIG. 1, the computing cluster device 2 receives the encrypted information piece to be processed, and the bridging computing module 21 includes a plurality of bridging computing units 210, 211 and 212 which are connected in series, wherein an end of the serial connected bridging computing units 210, 211 and 212 is taken as an end bridging computing unit 210 to connect the computing task managing device 1. Furthermore, the subordinating computing module 22 includes a plurality of subordinating computing units 220, 221 and 222 which are connected in series, wherein an end of the serial connected subordinating computing units 220, 221 and 222 is taken as an end subordinating computing unit 220 to connect the end bridging computing unit 210.

Specifically, the computing task managing device 1 is configured to monitor a working status of each bridging computing unit 210, 211 and 212 to obtain a bridging computing unit feedback and monitor a working status of each subordinating computing unit 220, 221 and 222 to obtain a subordinating computing unit feedback such that according to the each bridging computing unit feedback and the each subordinating computing unit feedback, the plurality of encrypted information pieces to be processed is assigned to the bridging computing unit 210, 211, 212 whose bridging computing unit feedback indicating as in an idle state and/or the subordinating computing unit 220, 221, 222 whose subordinating computing unit feedback indicating as in an idle state to obtain a plurality of computing results from the assigned bridging computing unit and the assigned subordinating computing unit

As shown in FIG. 1, the end bridging computing unit 210 is configured to return the plurality of computing results to the computing task managing device 1. The information ciphering module 12 is configured to decrypt the plurality of computing results. The computing task managing device 1 is configured to obtain decrypted computing information from the plurality of decrypted computing results and return the decrypted computing information to the information device D. Specifically, the information ciphering module 12 is a firmware module in which the firmware includes a program of communication protocol to encode the information to be processed (encryption) and decode the computing result (decryption).

In one embodiment of the present invention, the computing task managing device 1 is further provided with an information transmission module 11 connected to the information device D and the information ciphering module 12 to transmit the information to be processed to the information ciphering module 12 for encryption and return the decrypted computing information to the information device D. In other words, the information transmission module 11 functions as an I/O interface for information transmission between the computing task managing device 1 and the information device D. Specifically, the information transmission module 11 may be a serial peripheral interface (SPI) connected between the computing task managing device 1 and the information device D to enable the computing task managing device 1 to receive the information to be processed from one information device D or a plurality of information devices D.

Furthermore, as shown in FIG. 1, the plurality of bridging computing units 210, 211 and 212 are arranged in a straight line and adjacent two of the bridging computing units are informationally connected with each other. The end bridging computing unit 210 is arranged at an end of the straight line, and the bridging computing unit 212 arranged at the other end of the straight line is informationally connected to the end bridging computing unit 210 to return the computing results of the plurality of bridging computing units 210, 211 and 212 to the computing task managing device 1. The plurality of subordinating computing units 220, 221 and 222 are arranged in a straight line and adjacent two of the subordinating computing units are informationally connected with each other. The end subordinating computing unit 220 is arranged at an end of the straight line, and the subordinating computing unit 222 arranged at the other end of the straight line is informationally connected to the end bridging computing unit 220 to return the computing results of the subordinating computing units 220, 221 and 222 to the computing task managing device 1 via the end bridging computing unit 210.

In one embodiment of the present invention, the plurality of bridging computing units 210, 211 and 212 and the plurality of subordinating computing units 220, 221 and 222 are arranged in a checkerboard matrix. The bridging computing units 210, 211 and 212 and the subordinating computing units 220, 221 and 222 are a unified processing unit or computing network configured to exclusively perform a computing operation. In the embodiment, the plurality of bridging computing units 210, 211 and 212 and the plurality of subordinating computing units 220, 221 and 222 are unified to have similar computing processing capacities and can handle a condition of complex computational requirement by normalized operations through a networked combined operation, that is, the bridging computing units 210, 211 and 212 and the subordinating computing units 220, 221 and 222 are implemented as a high performance computing (HPC) system.

In the distributed computing system according to the embodiment of the present invention, according to the bridging computing unit feedback and the subordinating computing unit feedback, the computing task managing device 1 distributes the information to be processed and dispatches the idle bridging computing unit 210, 211, 212 and/or the idle subordinating computing unit 220, 221, 222 to perform the computing operation for the information to be processed. In this way, the computing task managing device 1 balances the computing load of the plurality of the computing units of the computing cluster device 2 and thus improve the overall work efficiency of the computing cluster device 2.

Furthermore, the information ciphering module 12 of the computing task managing device 1 is configured to encrypt the information to be processed and decrypt the computing result so that the information transmission between the computing task managing device 1 and the computing cluster device 2 can be a secure information connection. Therefore, even if the computing cluster device 2 must handle different computing operations for several information devices D, data leakage of important information from one information device D to another information device D through the information transmission can be prevented by the computing task managing device 1 encrypting and decrypting the information to be processed.

Moreover, the connections among the bridging computing units 210, 211, 212, among the subordinating computing units 220, 221, 222, and between the bridging computing unit and the subordinating computing unit are a one-way information transmission, and the information transmission in the computing cluster device 2 is fast and efficient and thereby contributing to the efficiency improvement of the distributed computing system.

The above description is only an explanation of the preferred embodiments of the present invention. One having ordinary skill in the art can make various modifications according to the above description and the claims defined below. However, those modifications shall still fall within the scope of the present invention.

What is claimed is:

1. A distributed computing system, comprising:
a computing task managing device being configured to receive, from an information device which is connected to the computing task managing device, information to be processed and distribute the information to be processed into a plurality of information pieces to be processed, each information piece to be processed being provided for performing an individual task, the computing task managing device being provided with an information ciphering module which is configured to encrypt the information pieces to be processed to obtain a plurality of encrypted information pieces to be processed; and
a computing cluster device receiving the encrypted information piece to be processed, the computing cluster device including at least one bridging computing module and at least one subordinating computing module, the bridging computing module including a plurality of bridging computing units which are connected in series, and the subordinating computing module including a plurality of subordinating computing units which are connected in series, wherein an end of the serial connected bridging computing units is taken as an end bridging computing unit to connect the computing task managing device, and an end of the serial connected subordinating computing units is taken as an end subordinating computing unit to connect the end bridging computing unit,
wherein the computing task managing device is configured to monitor a working status of each bridging computing unit to obtain a bridging computing unit feedback and monitor a working status of each subordinating computing unit to obtain a subordinating computing unit feedback such that according to the each bridging computing unit feedback and the each subordinating computing unit feedback, the plurality of encrypted information pieces to be processed is assigned to the bridging computing unit whose bridging computing unit feedback indicating as in an idle state and/or the subordinating computing unit whose subordinating computing unit feedback indicating as in an idle state to obtain a plurality of computing results from the assigned bridging computing unit and the assigned subordinating computing unit, and wherein the end bridging computing unit is configured to return the plurality of computing results to the computing task managing device, the information ciphering module is configured to decrypt the plurality of computing results, and the computing task managing device is configured to obtain decrypted computing information from the plurality of decrypted computing results and return the decrypted computing information to the information device.

2. The distributed computing system as claimed in claim 1, wherein the plurality of bridging computing units are arranged in a straight line and adjacent two of the bridging computing units are informationally connected with each other, the end bridging computing unit is arranged at an end of the straight line, and the bridging computing unit arranged at the other end of the straight line is informationally connected to the end bridging computing unit to return the computing results of the plurality of bridging computing units to the computing task managing device.

3. The distributed computing system as claimed in claim 1, wherein the plurality of subordinating computing units are arranged in a straight line and adjacent two of the subordinating computing units are informationally connected with each other, the end subordinating computing unit is arranged at an end of the straight line, and the subordinating computing unit arranged at the other end of the straight line is informationally connected to the end bridging computing unit to return the computing results of the subordinating computing units to the computing task managing device via the end bridging computing unit.

4. The distributed computing system as claimed in claim 1, wherein the computing task managing device is further provided with an information transmission module connected to the information device and the information ciphering module to transmit the information to be processed to the information ciphering module for encryption and return the decrypted computing information to the information device.

5. The distributed computing system as claimed in claim 1, wherein the plurality of bridging computing units and the plurality of subordinating computing units are arranged in a checkerboard matrix.

6. The distributed computing system as claimed in claim 1, wherein the bridging computing unit and the subordinating computing unit are a unified processing unit or computing network configured to exclusively perform a computing operation.
